(19) United States
(12) Patent Application Publication
(10) Pub. No.: US 2010/0037622 A1
(43) Pub. Date: Feb. 18, 2010

(54) Contoured Impingement Sleeve Holes

(75) Inventors: John Simo, Simpsonville, SC (US); Wei Chen, Greer, SC (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 12/193,239

(22) Filed: Aug. 18, 2008

(51) Int. Cl. F02C 7/18; F23R 3/06

(52) U.S. Cl. 60/754; 60/772

(57) ABSTRACT

A combustor for use with a gas turbine. The combustor may include liner, an impingement sleeve, and with the liner and the impingement sleeve defining an airflow channel. The impingement sleeve may include a number of contoured holes therethrough.

### TECHNICAL FIELD

The present application relates generally to gas turbine engines and more particularly relates to an impingement sleeve for a combustor having contoured holes therethrough.

### BACKGROUND OF THE INVENTION

Generally described, a gas turbine engine includes a compressor for compressing an incoming flow of air, a combustor for mixing the compressed air with a flow of fuel and igniting the mixture, and a turbine to drive the compressor and an external load such as an electrical generator and the like. In order to cool the combustor, an impingement sleeve may be used to direct cooling air to hot regions thereon. The impingement sleeve generally uses sharp edged holes so as to direct the cooling air where needed.

The sharp edged holes of the impingement sleeve, however, may present a blockage to the airflow and therefore reduce overall machine efficiency. Specifically, this blockage may result in a pressure drop across the impingement sleeve. Such a pressure drop normally may be tuned by changing the size of the impingement sleeve holes. Although this approach may reduce the pressure drop, the increased size also may reduce the cooling heat transfer.

Moreover, combustion within the combustor may be somewhat unsteady such that small scale variations within the combustion flame may lead to large scale pressure fluctuations. These pressure fluctuations or “dynamics” may transfer energy to the combustor so as to cause structural vibrations therein. As the vibration cycles accumulate over time, fatigue failure may be possible. These combustor pressure fluctuations have been controlled in the past by the use of a resonator device. These resonator devices, however, generally target discrete or narrow band frequencies as opposed to a wide range of dynamic pressure oscillations.

There is therefore a desire to provide improved pressure drop control, dynamics control, and thermal distribution control with respect to combustor cooling. Preferably, improving combustor cooling while reducing the pressure drop and the dynamics across the impingement sleeve may increase the overall efficiency and durability of the gas turbine engine.

### SUMMARY OF THE INVENTION

The present application thus describes a combustor for use with a gas turbine engine. The combustor may include liner, an impingement sleeve, and with the liner and the impingement sleeve defining an airflow channel. The impingement sleeve may include a number of contoured holes therethrough.

The present application further describes a method of operating a combustor. The method includes the steps of providing the combustor with an impingement sleeve with a number of contoured holes therein, directing a flow of air towards the combustor, and directing at least part of the flow of air through the contoured holes to cool the combustor.

The present application further describes a reverse flow combustor. The reverse flow combustor may include a combustion chamber, a liner surrounding the combustion chamber, an impingement sleeve, and with the liner and the impingement sleeve defining a cooling airflow channel. The impingement sleeve may include a number of contoured holes therethrough.

These and other features of the present application will become apparent to one of ordinary skill in the art upon review of the following detailed description of the preferred embodiments when taken in conjunction with the several drawings and the appended claims.

### BRIEF DESCRIPTION OF THE DRAWINGS

FIG. 1 is a schematic view of a gas turbine engine.

FIG. 2 is a side cross-sectional view of a combustor with a known impingement sleeve.

FIG. 3 is a side cross-sectional view of a known sharp edged impingement hole.

FIG. 4 is a side cross-sectional view of a contoured impingement hole as is described herein.

### DETAILED DESCRIPTION

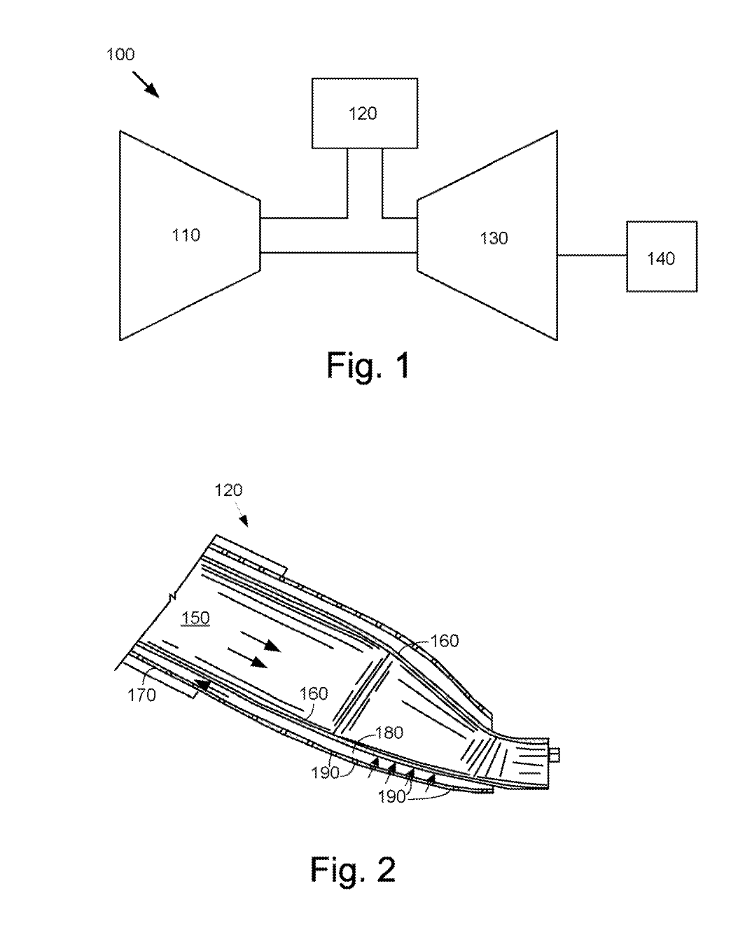

Referring now to the drawings in which like numbers refer to like elements throughout the several views, FIG. 1 shows a schematic view of a gas turbine engine 100. As described above, the gas turbine engine 100 may include a compressor 110 to compress an incoming flow of air. The compressor 110 delivers the compressed flow of air to a combustor 120. The combustor 120 mixes the compressed flow of air with a flow of fuel and ignites the mixture. The hot combustion gases are in turn delivered to a turbine 130 so as to drive the compressor 110 and an external load 140 such as an electrical generator and the like. The gas turbine engine 100 may use other figurations and components herein.

FIG. 2 shows a further view of the combustor 120. In this example, the combustor 120 may be a reverse flow combustor. Any number of different combustor configurations 120, however, may be used herein. For example, the combustor 120 may include forward mounted fuel injectors, multi-tube aft fed injectors, single tube aft fed injectors, wall fed injectors, staged wall injectors, and other configurations that may be used herein.

As described above, high pressure air may exit the compressor 110, reverse direction along the outside of a combustion chamber 150, and reverse flow again as the air enters the combustion chamber 150 where the fuel/air mixture is ignited. Other flow configurations may be used herein. The combusted hot gases provide high radiative and convective heat loading along the combustion chamber 150 before the gases pass on to the turbine 130. Cooling of the combustion chamber 150 thus is required given the high temperature gas flow.

The combustion chamber 150 thus may include a liner 160 so as to provide a cooling flow. The liner 160 may be positioned within an impingement sleeve 170 so as to create an airflow channel 180 therebetween. At least a portion of the air flow from the compressor 10 may pass through the impingement sleeve 170 and into the airflow channel 180. The air may be directed over the liner 160 for cooling the liner 160 before entry into the combustion chamber 140 or otherwise.

The impingement sleeve 170 divides the incoming flow into several discrete jets so as to provide highly localized backside cooling along the liner 160. The conversion of the incoming compressor flow into the high velocity jets, however, involves a static pressure penalty. Specifically, the pressure drop across the impingement sleeve 170 may be proportional to the level of cooling heat transfer. Greater cooling may be provided through higher jet velocities but at a penalty of increasingly higher pressure drops.

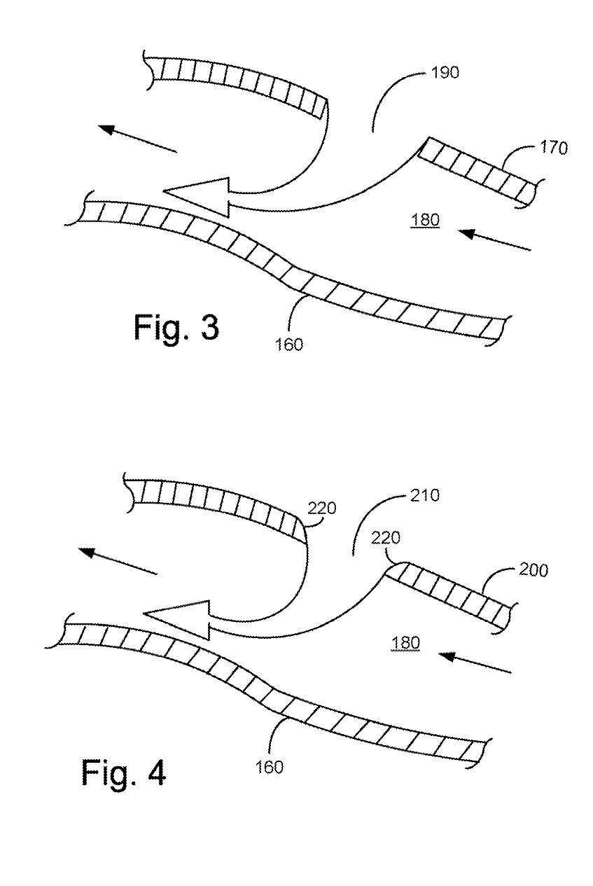

FIG. 3 shows a known impingement sleeve 170 with a sharp edged hole 190 positioned therein. As described above, a reduction in the pressure drop across the impingement sleeve 170 has generally resulted in the use of larger sharp edged holes. Likewise, pressure fluctuations within the impingement sleeve 170 also may cause mechanical vibrations therein that may lead to fatigue failure. Note that the incoming air jet is attached only at the inlet of the sharp edged hole 190.

FIG. 4 shows an impingement sleeve 200 with contoured holes 210 as is described herein. The contoured holes 210 may have the same diameter as the sharp edged holes 190 described above, but the use of the contour allows for a stronger and/or faster jet of cooling air and hence more overall cooling. As is shown, the contoured holes 210 may be contoured on the outer edge thereof with a curved radius 220 thereon instead of the straight wall holes 190 described above. Other types, shapes, and sizes of the contours may be used herein. Differently sized holes 210 may be used herein. The contoured holes 210 may be provided by conventional machining techniques or other type of conventional manufacturing techniques.

As compared to the sharp edged hole 190, the incoming air jet attaches to the entire curved radius 220 of the contoured holes 210. The contoured holes 210 thus may provide less air resistance through the holes 210 so as to reduce the pressure drop across the impingement sleeve 200, increase overall machine efficiency, and increase overall output. The contour holes 210 also may reduce the combustor dynamic pressure fluctuations. Specifically, the contour holes 210 may control the dynamics by providing a larger impedance ratio. The impedance ratio segregates the interaction of forward pressure waves with the backward pressure waves in the gas turbine engine 100 as a whole. By such separation, viscous damping dominates as a damping mechanism such that any pressure fluctuations may be attenuated. The impedance ratio also may be a function of overall operating conditions. As the magnitude of pressure oscillations increase, the impedance ratio also may increase. This high damping combined with a broad range of frequencies may result in a potentially robust overall system.

The use of the contoured holes 210 thus reduces the overall pressure drop and the dynamics while minimizing the impact to heat transfer. Moreover, lower component temperatures should provide increased durability. A combination of sharp edged holes 190 and contoured holes 210 also may be used. Existing sharp edged holes 190 also may be retrofitted to the contoured holes 210.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A combustor, comprising:
a liner;
an impingement sleeve;
the liner and the impingement sleeve defining an airflow channel; and
the impingement sleeve comprising a plurality of contoured holes therethrough.

2. The combustor of claim 1, wherein the combustor comprises a reverse flow combustor.

3. The combustor of claim 1, further comprising a combustion chamber defined by the liner.

4. The combustor of claim 1, wherein the plurality of contoured holes comprises a curved radius thereon.

5. The combustor of claim 1, wherein the impingement sleeve comprises a plurality of sharp edged holes.

6. The combustor of clam 1, wherein the plurality of contoured holes comprises a plurality of different sizes.

7. A method of operating a combustor, comprising:
providing the combustor with an impingement sleeve with a plurality of contoured holes therein;
directing a flow of air towards the combustor; and
directing at least part of the flow of air through the plurality of contoured holes to cool the combustor.

8. The method of claim 7, further comprising retrofitting an existing impingement sleeve with the plurality of contoured holes.

9. The method of claim 7, wherein use of the plurality of contoured holes reduces the pressure drop across the impingement sleeve as compared to an impingement sleeve with a plurality of sharp edged holes.

10. The method of claim 7, wherein use of the plurality of contoured holes reduces air resistance across the impingement sleeve as compared to an impingement sleeve with a plurality of sharp edged holes.

11. The method of claim 7, wherein use of the plurality of contoured holes reduces the pressure dynamics across the impingement sleeve as compared to an impingement sleeve with a plurality of sharp edged holes.

12. The method of claim 7, wherein use of the plurality of contoured holes improves cooling across the impingement sleeve as compared to an impingement sleeve with a plurality of sharp edged holes.

13. A reverse flow combustor, comprising:
a combustion chamber;
a liner surrounding the combustion chamber;
an impingement sleeve;
the liner and the impingement sleeve defining a cooling airflow channel; and
the impingement sleeve comprising a plurality of contoured holes therethrough.

14. The reverse flow combustor of claim 13, wherein the plurality of contoured holes comprises a curved radius thereon.

15. The reverse flow combustor of claim 13, wherein the impingement sleeve comprises a plurality of sharp edged holes.

16. The reverse flow combustor of clam 13, wherein the plurality of contoured holes comprises a plurality of different sizes.
